(19) United States
(12) Patent Application Publication
(10) Pub. No.: US 2009/0296024 A1
(43) Pub. Date: Dec. 3, 2009

(54) LIGHT DIFFUSER PLATE WITH PRIMER LAYER, PROCESS FOR PRODUCING THE SAME, LAMINATED OPTICAL MEMBER, SURFACE LIGHT SOURCE APPARATUS AND LIQUID CRYSTAL DISPLAY

(75) Inventors: Hiroko Kanaya, Niihama-shi (JP); Akiyoshi Kanemitsu, Niihama-shi (JP); Masaharu Mori, Mitoyo-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/404,637

(22) Filed: Mar. 16, 2009

(30) Foreign Application Priority Data
Mar. 18, 2008 (JP) 2008-069858
Mar. 27, 2008 (JP) 2008-082528
Mar. 27, 2008 (JP) 2008-082533

(51) Int. Cl. G02F 1/13357; G02B 5/02; B32B 37/12

(52) U.S. Cl. 349/64; 362/97.1; 359/599; 156/60

(57) ABSTRACT

The present invention relates to a light-diffuser-plate-with-primer-layer, which permits lamination of an optical film or the like thereon with a sufficient bonding strength, and a process for producing the same efficiently and at a lower cost.

### TECHNICAL FIELD

The present application is filed, claiming the Paris Convention priorities of Japanese Patent Application Nos. 2008-069858 (filed on Mar. 18, 2008), 2008-082528 (filed on Mar. 27, 2008) and 2008-082533 (filed on Mar. 27, 2008), the entire contents of which are incorporated herein by reference.

The present invention relates to a light-diffuser-plate-with-primer-layer, which permits lamination of an optical film or the like thereon with a sufficient bonding strength, and a process for producing the same light diffuser plate at a higher efficiency and at a lower cost.

### BACKGROUND ART

For example, a typically known liquid crystal display comprises a liquid crystal panel (an image-displaying member) including a liquid crystal cell, and a surface light source apparatus as a backlight disposed on the back side of the liquid crystal panel. As this surface light source apparatus for use as a backlight, there is known a surface light source apparatus comprising a lamp box (a casing), a plurality of light sources disposed in the lamp box, and a light diffuser plate set to be at the front side of these light sources (cf. Patent Publication 1).

In such a surface light source apparatus for use as a backlight, a variety of optical films such as a light-diffusing film, a prism sheet, a reflection type light-polarization separation film, etc. are generally laminated and set to be at the front side of a light diffuser plate. However, despite an increasing demand for large-sized liquid crystal displays in these years, the handling efficiency for assembling such surface light source apparatuses tends to degrade. Improvement of handling efficiency for integrating a light diffuser plate with optical films is therefore required.

Previous integration of a variety of optical films is proposed in order to improve such handling efficiency. For example, Patent Publication 2 discloses that a first deflecting sheet and a second deflecting sheet are integrally laminated on each other, wherein spacer protrusions are formed on the first deflecting sheet so as to form an air gap between these deflecting sheets, so that sufficient optical performance can be ensured because of the presence of this air gap.

Patent Publication 1: JP-A-2004-170937

Patent Publication 2: JP-A-2006-337753

### DISCLOSURE OF THE INVENTION

### Problem to be Solved by the Invention

However, the latter conventional technique has the following problem: when the other optical sheet is bonded to the protrusion-formed surface (or uneven surface) of the former one optical sheet, these optical sheets are apt to peel from each other because no sufficient bonding area is ensured, which results in insufficient bonding strength.

As a result of the present inventor's intensive studies to solve The problem, it is found that a laminated optical member excellent in bonding strength for lamination can be obtained by laminating a primer layer on at least one surface of a light diffuser plate, and integrally laminating an optical film on the primer layer through an adhesive layer.

In the meantime, when a primer layer is formed by a conventional coating method, that is, by applying a primer solution from above to the uneven surface of a light diffuser plate which is laid with its uneven surface faced upward, the primer solution Lends to stay on the bottom (or the grooves) of the uneven surface of the light diffuser plate. This is undesirable because a sufficient air gap (air portion) can not be formed between the light diffuser plate and an optical film or the like, and because a sufficient amount of the primer solution, contributing to improvement of bonding strength, can not be applied to the protrusions (tops of the protrusions) of the uneven surface of the light diffuser plate.

In case where a primer solution which usually contains a solvent is applied to a light diffuser plate, a step for drying the solvent from the primer solution is separately needed, which may lead to poor productivity, and an apparatus for drying the solvent is further needed, which may lead to an increased cost.

The present invention is developed in consideration of the above-described technical background, and an object of the present invention is therefore to provide a light diffuser plate which permits lamination of another optical film or the like thereon with a sufficient bonding strength.

Other objects of the present invention are to provide a light diffuser plate which can ensure a sufficient air gap between itself and another optical film or the like and also can ensure a sufficient bonding strength for lamination, and to provide a laminated optical member which can ensure a sufficient luminance as well as a sufficient bonding strength for lamination.

Further objects of the present invention are to provide a process for producing a light-diffuser-plate-with-primer-layer, capable of ensuring a sufficient air gap between itself and another optical film or the like and also capable of ensuring a sufficient bonding strength for lamination, and to provide a process for producing a laminated optical member.

Still further objects of the present invention are to provide a process for producing a light-diffuser-plate-with-primer-layer, capable of ensuring a sufficient bonding strength for lamination between itself and another optical film or the like, at a higher efficiency and at a lower cost; and to provide a process for producing a laminated optical member in which a light diffuser plate and an optical film are laminated on each other with a sufficient bonding strength, at a higher efficiency and at a lower cost.

### Means for Solving the Problem

[1] A light-diffuser-plate-with-primer-layer, wherein the primer layer is laminated on at least one surface of a light diffuser plate.

[2] The light-diffuser-plate-with-primer-layer according to the item [1], wherein the primer layer-contacting surface of the light diffuser plate is formed uneven, having an irregular cross-sectional shape and having a ten-point height of roughness profile (Rz) of from 20 to 100 μm [(Rz): a value measured according to JIS B0601-1994].

[3] The light-diffuser-plate-with-primer-layer according to the item [1], wherein the primer layer-contacting surface of the light diffuser plate is formed uneven, having a regular cross-sectional shape.

[4] The light-diffuser-plate-with-primer-layer according to the item [3], wherein the regular cross-sectional shape is at least one shape selected from the group consisting of a lenticular lens shape, a waveform shape and a prismatic shape.

[5] A process for producing the light-diffuser-plate-with-primer-layer according to any one of the items [1] to [4], wherein a diffuser plate having at least one surface formed uneven is set with its uneven surface faced downward, and a primer solution is applied from below the uneven surface faced downward of the light diffuser plate.

[6] The process according to the item [5], wherein the primer solution is applied by a roller coating method.

[7] The process according to the item [5], wherein the primer solution is applied by a spray coating method.

[8] A process for producing a laminated optical member, comprising the steps of
producing a laminated film in which an adhesive layer is laminated on one surface of an optical film,
producing a light-diffuser-plate-with-primer-layer as according to any one of the items [1] to [4], by setting a light diffuser plate having at least one surface formed uneven, with its uneven surface faced downward, and applying a primer solution from below the uneven surface faced downward of the light diffuser plate (a coating step), and
integrally laminating the light diffuser plate on the laminated film, by superposing them on each other so that the primer solution-applied uneven surface of the light diffuser plate can contact the adhesive layer of the laminated film.

[9] A process for producing the light-diffuser-plate-with-primer-layer according to any one of the items [1] to [4], wherein a primer solution is applied to at least one surface of a light diffuser plate whose temperature is 50° C. or higher.

[10] The process for producing the light-diffuser-plate-with-primer-layer according to the item [9], wherein the primer solution is applied to at least one surface of a light diffuser plate which is extruded from an extruder and retains a temperature of 50° C. or higher due to the residual heat of extrusion.

[11] The process for producing the light-diffuser-plate-with-primer-layer according to the item [9] or [10], wherein at least one surface of a light diffuser plate is formed uneven, and the primer solution is applied to the uneven surface thereof.

[12] The process for producing the light-diffuser-plate-with-primer-layer according to any one of the items [9] to [11], wherein an aqueous primer solution is used as the primer solution.

[13] A process for producing a laminated optical member, comprising the steps of
producing a laminated film in which an adhesive layer is laminated on one surface of an optical film,
producing the light-diffuser-plate-with-primer-layer according to any one of the items [1] to [4], by applying a primer solution to at least one surface of a light diffuser plate whose temperature is 50° C. or higher, and
integrally laminating the light diffuser plate and the laminated film on each other by superposing them on each other so that the primer solution-applied surface of the light diffuser plate can contact the adhesive layer of the laminated film.

[14] A laminated optical member, wherein an optical film is integrally laminated on the primer layer of the light-diffuser-plate-with-primer-layer according to any one of the items [1] to [4], through the adhesive layer.

[15] A laminated optical member, wherein an optical film is integrally laminated on the primer layer of the light-diffuser-plate-with-primer-layer according to any one of the items [1] to [4], through an adhesive layer, and an air gap is formed between the adhesive layer and the primer layer laminated alongside the uneven pattern of the uneven surface of the light diffuser plate.

[16] A surface light source apparatus comprising the laminated optical member according to the item [14] or [15] and a plurality of light sources disposed on the back side of the laminated optical member, wherein the optical film is set to be at the front side of the laminated optical member.

[17] A liquid crystal display comprising the laminated optical member according to the item [14] or [15], a plurality of light sources disposed on the back side of the laminated optical member, and a liquid crystal panel disposed on the front side of the laminated optical member, wherein the optical film is set to be at the front side of the laminated optical member.

In the invention of the item [1], the primer layer is laminated on at least one surface of a light diffuser plate, so that another optical film or the like can be laminated on the light diffuser plate through the adhesive layer with a sufficient bonding strength.

In the invention of the item [2], the primer layer-contacting surface of the light diffuser plate is formed uneven, having an irregular cross-sectional shape with a ten-point height of roughness profile (Rz) of from 20 to 100 μm, so that a sufficient bonding strength can be ensured and so that a sufficient air gap can be formed between the light diffuser plate and another optical film, with the result that a sufficient luminance as a laminated optical member can be ensured.

In the invention of the item [3], the primer layer-contacting surface of the light diffuser plate is formed uneven, having a regular cross-sectional shape, so that a sufficient bonding strength can be ensured and so that a sufficient air gap can be formed between the light diffuser plate and another optical film, with the result that a sufficient luminance as a laminated optical member can be ensured.

In the invention of the item [4], the regular cross-sectional shape is of at least one selected from the group consisting of the lenticular lens shape, the waveform shape and the prismatic shape, so that a luminance as a laminated optical member can be further improved.

In the invention of the item [5], the primer solution is applied from below the uneven surface faced downward of the light diffuser plate, so that the primer solution can be prevented from staying on the bottom (or grooves) of the uneven surface of the light diffuser plate, to thereby ensure a sufficient air gap, for example, between the light diffuser plate and another optical film, and to thereby sufficiently apply the primer solution to the protrusions of the uneven surface of the light diffuser plate, which makes it sure to obtain a sufficient bonding strength, for example, between the light diffuser plate and another optical film.

In the invention of the item [6], the primer solution is applied by the roller coating method, so that it becomes possible to selectively apply the primer solution to the protrusions of the uneven surface of the light diffuser plate, to thereby sufficiently prevent the primer solution from staying on the bottom (or grooves) of the uneven surface of the light diffuser plate, with the result that a sufficient air gap can be ensured, for example, between the light diffuser plate and another optical film, and so that a light-diffuser-plate-with-primer-layer, capable of ensuring a sufficient bonding strength, can be efficiently produced.

In the invention of the item [7], the primer solution is applied by the spray coating method, so that a sufficient air gap can be ensured between the light diffuser plate and another optical film, and so that a light-diffuser-plate-with-primer-layer, capable of ensuring a sufficient bonding strength, can be efficiently produced.

In the invention of the item [8], the primer solution is applied from below the uneven surface faced downward of the light diffuser plate, so that the primer solution can be prevented from staying on the bottom (or grooves) of the uneven surface of the light diffuser plate, to thereby ensure a sufficient air gap between the light diffuser plate and an optical film, and to thereby sufficiently apply the primer solution to the protrusions of the uneven surface of the light diffuser plate, which makes it sure to obtain a sufficient bonding strength between the light diffuser plate and the optical film.

In the invention of the item [9], the primer solution is applied to at least one surface of a light diffuser plate whose temperature is 50° C. or higher, and therefore, the primer solution can be dried by heat from the light diffuser plate itself without any need of a separate drying apparatus (or a drying step). The productivity of a light-diffuser-plate-with-primer-layer is therefore superior, and the cost for the apparatus can be greatly reduced. The light diffuser plate obtained by the present process has the primer layer formed on at least one surface thereof, so that another optical film or the like can be laminated on the light diffuser plate through an adhesive with a sufficient bonding strength.

In the invention of the item [10], the primer solution is applied to at least one surface of a light diffuser plate whose temperature is 50° C. or higher due to remaining heat of the light diffuser plate which has been extruded from an extruder: that is, the primer solution is dried by making use of the remaining heat of the light diffuser plate extruded. Therefore, no separate drying apparatus (or drying step) is needed, which leads to a higher productivity and further to a great decrease in the cost for the apparatus. The light diffuser plate obtained by the present process has the primer layer laminated on its at least one surface, and thus, another optical film or the like can be laminated on this light diffuser plate through an adhesive with a sufficient bonding strength.

In the invention of the item [11], at least one surface of a light diffuser plate is formed uneven, and the primer solution is applied to the uneven surface of the light diffuser plate, so that a sufficient air gap can be ensured, for example, between the light diffuser plate and another optical film or the like, which leads to improvement of a luminance.

In the invention of the item [12], the aqueous primer solution is applied, which is advantageous to sufficiently improve the work environment in the production site, as compared with the use of an organic solvent or the like.

In the invention of the item [13], the primer solution is applied to at least one surface of a light diffuser plate whose temperature is 50° C. or higher, so that the primer solution can be dried by heat from the light diffuser plate itself without any need of a separate drying apparatus (or a drying step). Accordingly, a laminated optical member can be produced at a higher production efficiency and at a lower cost. A laminated optical member obtained by the present process has an optical film integrally laminated on the primer layer of the light diffuser plate through the adhesive layer, and thus is excellent in bonding strength.

In the invention of the item [14], the optical film is integrally laminated on the primer layer of the light diffuser plate having any of the above-described structures, through the adhesive layer. Therefore, a laminated optical member excellent in bonding strength can be provided.

In the invention of the item [15], the optical film is integrally laminated on the primer layer of the light diffuser plate having any of the above-described structures, through the adhesive layer, and the air gap is formed between the adhesive layer and the primer layer which is laminated alongside the uneven pattern of the uneven surface of the light diffuser plate. Therefore, a laminated optical member capable of ensuring a sufficient luminance and excellent in bonding strength can be provided.

In the invention of the item [16], the surface light source apparatus is assembled using the laminated optical member comprising the light diffuser plate and the optical film laminated on each other. Therefore, the surface light source apparatus is improved in handling efficiency, and thus is excellent in productivity, ensuring a sufficient bonding strength between the light diffuser plate and the optical film, and showing a high quality and a high luminance.

In the invention of the item [17], the liquid crystal display is assembled using the laminated optical member comprising the light diffuser plate and the optical film laminated on each other. Therefore, the liquid crystal display is improved in handling efficiency, and thus is excellent in productivity, ensuring a sufficient bonding strength between the light diffuser plate and the optical film, and showing a high quality and a high luminance.

### BRIEF DESCRIPTION OF THE DRAWINGS

FIG. 1 shows a sectional view of the light-diffuser-plate-with-primer-layer according to an embodiment of the present invention.

FIG. 1-21 shows a schematic side elevation diagram illustrating an example of a process for producing the light-diffuser-plate-with-primer-layer according to the present invention.

FIG. 1-22 shows a schematic side elevation diagram illustrating another example of a process for producing the light-diffuser-plate-with-primer-layer according to the present invention.

FIG. 1-31 shows a schematic side elevation diagram illustrating other example of a process for producing the light-diffuser-plate-with-primer-layer according to the present invention.

FIG. 2 shows a sectional view of a laminated optical member according to an embodiment of the present invention.

FIG. 3 shows a schematic diagram illustrating a liquid crystal display according to an embodiment of the present invention.

FIG. 4 shows a sectional view of a laminated optical member, illustrating an example of the process for producing the same according to the present invention.

FIG. 4-27 shows a sectional view of a laminated optical member, illustrating another example of the process for producing the same according to the present invention.

FIG. 5 shows a sectional view of a laminated optical member according to another embodiment of the present invention.

FIG. 5-25 shows a sectional view of a laminated optical member according to other embodiment of the present invention.

FIG. 6 shows a sectional view of a laminated optical member according to a further embodiment of the present invention.

### DESCRIPTION OF REFERENCE NUMERALS

1=a surface light source apparatus
2=a light source
3=a laminated optical member
20=a liquid crystal panel
30=a liquid crystal display
31=a light diffuser plate
31a an uneven surface
32=a primer layer
33=a light-diffuser-plate-with-primer-layer
40=an adhesive layer
41=an optical film
42=a laminated film
43=an air gap
50=an extruder
51=a coating roller
53=a spray coating device

### BEST MODES FOR CARRYING OUT THE INVENTION

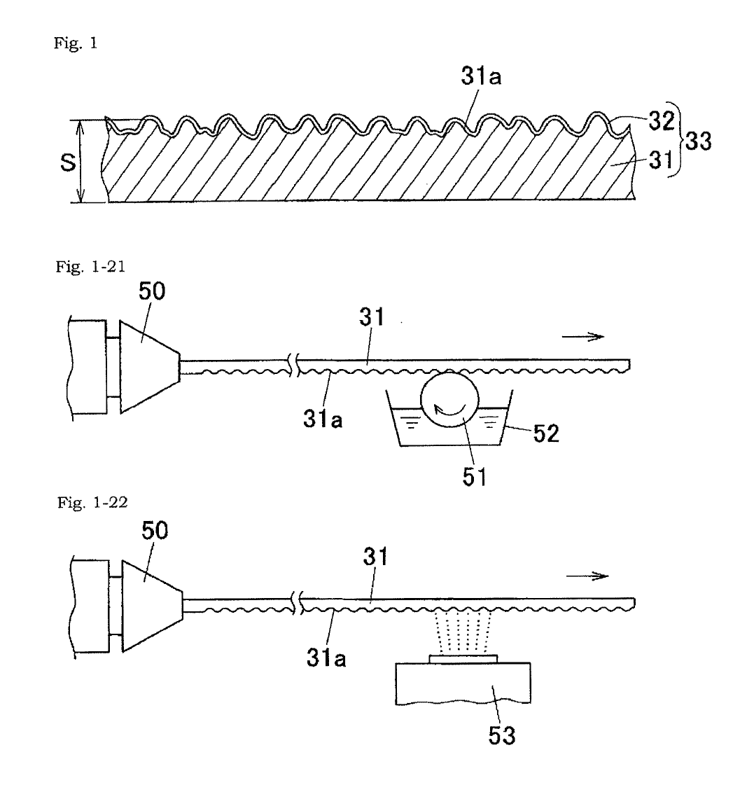

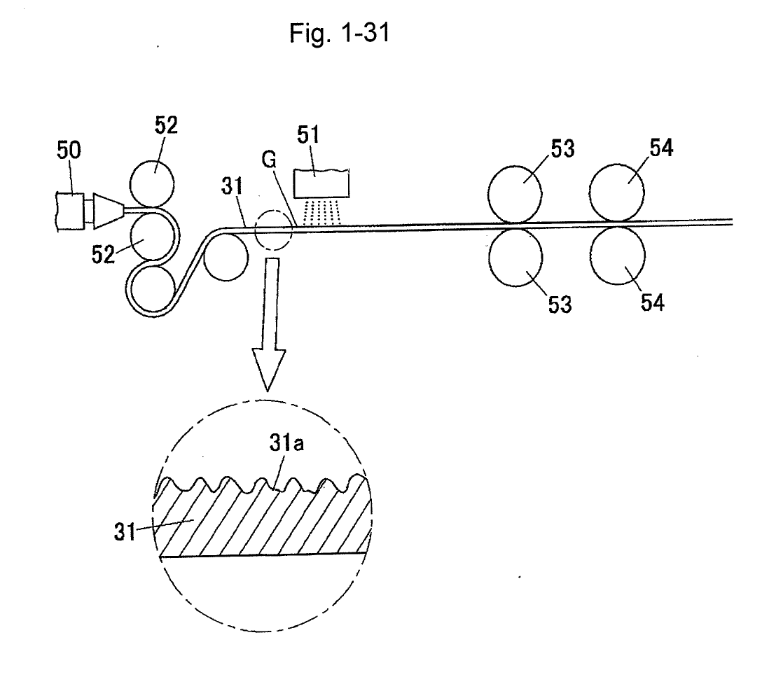

An embodiment of a light diffuser plate (33) with a primer layer according to the present invention is shown in FIG. 1. The light diffuser plate (33) with the primer layer comprises a light diffuser plate (31) and a primer layer (32) laminated on one surface of the light diffuser plate (31). In this embodiment, the surface of the light diffuser plate (31), in contact with the primer layer (32), is formed as an uneven surface (31a). While the primer layer (32) is laminated on only one surface of the light diffuser plate in this embodiment, the primer layers (32) may be laminated on both surfaces of the light diffuser plate (31).

As described above, the light diffuser plate (33) with the primer layer has the primer layer (32) laminated on at least one surface of a light diffuser plate (31), and thus, another optical film (41) or the like can be laminated on the light diffuser plate (33) with the primer layer through an adhesive layer (40) with a sufficient bonding strength.

In an embodiment of the present invention, a process for producing the light diffuser plate (33) with the primer layer of the present invention is characterized in that the light diffuser plate (31) having at least one surface formed as the uneven surface (31a) is set with its uneven surface (31a) faced downward, so that a primer solution is applied from below to the downward facing uneven surface (31a) of the light diffuser plate (31).

An example of the process of the present invention is described with reference to FIG. 1-21, in which a numeral (31) refers to a light diffuser plate having one surface formed as an uneven surface (31a); (50), to an extruder; (51), to a coating roller; and (52), to a coating liquid tank. A part of the coating roller (51) is dipped in a primer solution in the coating liquid tank (52), and the coating roller (51) is so arranged that its outer peripheral surface comes into contact with the downward facing uneven surface (31a) of the light diffuser plate (31) which is extruded and fed from the extruder (50). The coating roller (51) is rotated following the uneven surface (31a) of the light diffuser plate (31) which is being fed while contacting the outer peripheral surface of the coating roller (51). When the outer peripheral surface of the coating roller (51) contacts the downward facing uneven surface of the light diffuser plate (31), the primer solution can be applied from below to the uneven surface (31a) of the light diffuser plate (31). In this regard, a mat roller (not shown) which forms an uneven pattern on the light diffuser plate is located at a position in the front of the extruder (50).

When the light diffuser plate (31) is extruded from the extruder (50) as shown in FIG. 1-21, the light diffuser plate (31) is subjected to melt extrusion and transfer molding by the mat roller (not shown) so that one surface of the light diffuser plate (31) is formed as the uneven surface (31a), and the light diffuser plate (31) with its uneven surface (31a) faced downward is fed in a substantially horizontal state, and its downward facing uneven surface (31a) comes into contact with the outer peripheral surface of the coating roller (51), to thereby apply the primer solution from below to the uneven surface (31a) of the light diffuser plate. When the downward facing uneven surface (31a) of the light diffuser plate coated with the primer solution is dried, the primer solution can be prevented from staying on the bottom (or grooves) of the uneven surface (31a) of the light diffuser plate, and the primer solution can be sufficiently applied to the protrusions of the uneven surface (31a) of the light diffuser plate (see FIG. 1). Thus, the light diffuser plate (33) with the primer layer as shown in FIG. 1 can be produced.

According to another embodiment of the present invention, the process for producing a light-diffuser-plate-with-primer-layer is characterized in that a primer solution is applied to at least one surface of a light diffuser plate (31) whose temperature is 50° C. or higher.

An example of the process of the present invention will be described with reference to FIG. 1-31. In FIG. 1-31, a numeral (31) represents a light diffuser plate having one surface formed as an uneven surface (31a); (50), an extruder; (51), a spray coating device; (52), a cooling roller; (53), a masking roller; and (54), a take-up roller.

The spray coating device (51) is located at a position between the masking rollers (53) and the cooling rollers (52) in the front of the extruder (50) in an extruding direction. Located at such a position, the spray coating device (51) is caused to apply a primer solution to the uneven surface (31a) of the light diffuser plate (31) whose temperature is 50° C. or higher (at a position G in FIG. 1-31) because of remaining heat of the light diffuser plate which has been extruded and fed from the extruder (50). In addition, a mat roller (not shown) which forms an uneven pattern on one surface of the light diffuser plate is located between the extruder (50) and the cooling rollers (52).

As shown in FIG. 1-31, one surface of the light diffuser plate (31) just extruded from the extruder (50) is subjected to melt extrusion and transfer molding by the mat roller (not shown) to be formed as the uneven surface (31a). The light diffuser plate (31) is then fed by the cooling rollers (52) while being cooled. After that, the spray coating device (51) is caused to apply the primer solution to the uneven surface (31a) of the light diffuser plate (31) whose temperature is 50° C. or higher due to remaining heat of the light diffuser plate (31) extruded. At this point of time, the light diffuser plate (31) retains a temperature of 50° C. or higher due to remaining heat of the light diffuser plate extruded, and thus, the primer solution can be sufficiently dried off before the light diffuser plate reaches the next masking rollers (53). After that, the light diffuser plate (31) is allowed to pass through the masking rollers (53) and is then taken up by the take-up rollers (54). Thus, a light diffuser plate (33) with a primer layer, as shown in FIG. 1, can be provided. In other words, the light diffuser plate (33) can be produced by laminating the primer layer (32) on the uneven surface (31a) of the light diffuser plate (31).

According to the process of the present invention, as described above, the primer solution is applied to at least one surface of a light diffuser plate (31) retaining a temperature of 50° C. or higher. Preferably, the primer solution is applied to at least one surface of a light diffuser plate (31) retaining a temperature of from 50 to 120° C., more preferably from 50 to 95° C.

In the embodiment shown in FIG. 1-21, the primer solution is applied by the roller coating method. However, the coating method is not limited to this one, and the primer solution may be applied by a spray coating method with the use of a spray coating device (53) as shown in FIG. 1-22; or otherwise, the primer solution may be applied by a bar coating method, a die coating method, an ink jet method, a thermal ink jet method or the like.

In the embodiment shown in FIG. 1-31, the primer solution is applied by the spray coating method with the use of the spray coating device (51). However, the coating method is not limited to this one, and the primer solution may be applied by a roller coating method; or otherwise, the primer solution may be applied by a bar coating method, a die coating method, an ink jet method or the like.

In any of the above-described embodiments (shown in FIGS. 1-21, 1-22 and 1-31), the coating devices (51) and (53) are located on the production line using the extruder (50), so that the primer solution is continuously applied to the light diffuser plate (31) after the extrusion of the light diffuser plate (31). However, such a continuous production method may not be always employed: for example, the light diffuser plate (31) extruded from the extruder (50) may be sequentially cut into pieces with predetermined sizes, and the primer solution may be applied to theses cut pieces of the light diffuser plate (31) one by one.

In the above-described production process, desirably, the treatment of drying the primer solution is carried out after the application thereof. The drying method is not limited: for example, air drying or drying by heating is employed. Preferably, the drying treatment is made on the light diffuser plate (33) with its primer solution-applied uneven surface (31a) faced downward.

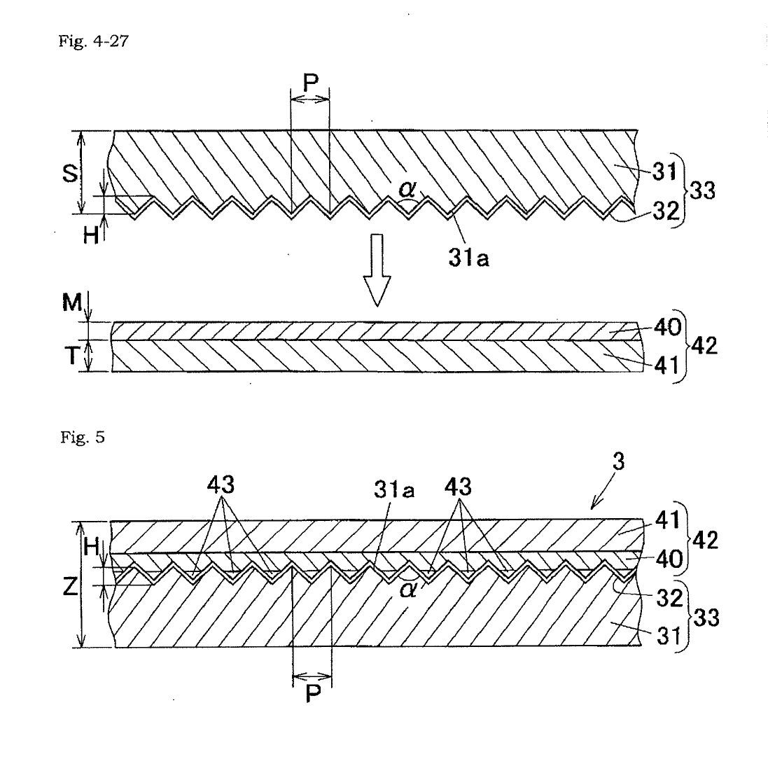

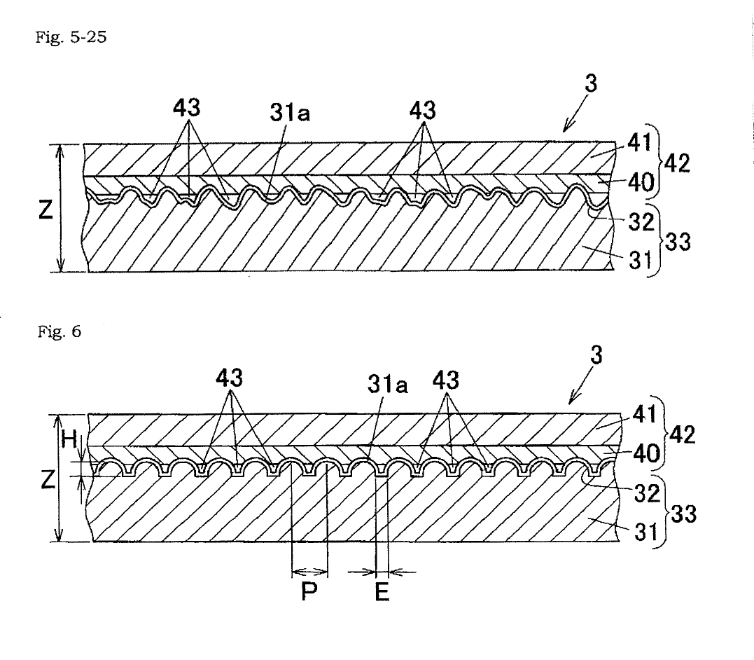

Next, a process for producing a laminated optical member (3) according to the present invention will be described. A laminated film (42) is obtained as follows: an adhesive is applied to one surface of an optical film (41), for example, by gravure coating, to thereby laminate the adhesive layer (40) on one surface of the optical film (41) (see FIG. 4). As shown in FIG. 4, the light diffuser plate (33) with the primer layer is set with its primer solution-applied uneven surface (31a) faced upward, and then, the laminated film (42) is superposed on the light diffuser plate (33) so that the adhesive layer of the laminated film (42) can contact the primer layer (32)-laminated uneven surface (31a) of the light diffuser plate (33), and both of them are pressed to thereby bond the light diffuser plate (33) to the optical film (41) with the adhesive layer (40). Thus, the laminated optical member (3) as shown in FIG. 5-25 is obtained.

The resultant laminated optical member (3) has a structure in which the optical film (41) is integrally laminated on the primer layer (32) of the light diffuser plate (33) through the adhesive layer (40). As seen in FIG. 5-25, an air gap (43) is formed between the adhesive layer (40) laminated on the optical film (41) and the primer layer (32) which is laminated in an irregular corrugated state alongside the uneven pattern of the uneven surface (31a) of the light diffuser plate (31).

That is, the use of the light diffuser plate (33) with the primer layer, obtained by the above-described process, makes it sure to prevent the staying of the primer solution on the bottom (or the grooves) of the uneven surface (31a) of the light diffuser plate (31) and also makes it sure to provide a sufficient air gap (43) between the light diffuser plate (31) and the optical film (41) (see FIG. 5-25). Again, the use of the light diffuser plate (33) with the primer layer, obtained by the above-described process, makes it sure to sufficiently apply the primer solution to the protrusions of the uneven surface (31a) of the light diffuser plate (31) and also makes it sure to obtain a sufficient bonding strength between the light diffuser plate (31) and the optical film (41).

In the foregoing embodiment, the adhesive layer (40) is laminated on substantially the entire surface, i.e., the adhesive-applied surface of the optical film (41) without any clearance therebetween; and the primer layer (32) is laminated on the uneven surface (31a) of the light diffuser plate (31) without any clearance therebetween.

In the laminated optical member (3), the sufficient air gap (43) is formed between the adhesive layer (40) and the primer layer (32) laminated alongside the uneven pattern of the uneven surface (31a) of the light diffuser plate (31): in other words, the sufficient air gap (43) is formed between the light diffuser plate (31) and the optical film (41). Therefore, a surface light source apparatus (1) or a liquid crystal display (30) assembled using this laminated optical member (3) reliably shows a sufficient luminance.

In the foregoing embodiment (see FIG. 4), the light diffuser plate (33) with the primer layer is pressed while its primer layer (32)-applied surface is faced upward. However, the pressing is not always done in this state: for example, as shown in FIG. 4-27, the light diffuser plate (33) with the primer layer is set with its primer layer (32) faced downward, while the laminated film (42) is set with its adhesive layer (40) faced upward; and the light diffuser plate (33) and the laminated film (42) are superposed and pressed on each other so that the adhesive layer (40) can partially contact the primer layer (32) laminated on the uneven surface (31a) of the light diffuser plate (33).

In the present invention, there is no limit in selection of the light diffuser plate (31), in so far as the plate has a light-diffusing function. For example, there is used a plate-shaped material which contains a light diffusing agent dispersed in a transparent material.

There is no limit in selection of the transparent material: for example, inorganic glass, a transparent resin or the like is used. A preferable example of the transparent resin is a transparent thermoplastic resin in view of its molding ease. There is no limit in selection of the transparent thermoplastic resin, and examples thereof include polycarbonate resins, ABS (acrylonitile-butadiene-styrene copolymer) resins, methacrylic resins, methyl methacrylate-styrene copolymer resins, polystyrene resins, acrylonitrile-styrene copolymer (AS) resins and polyolefin resins such as polyethylene resins and polypropylene resins.

There is no limit in selection of the light-diffusing agent, in so far as it is in the form of particles (including powder) which are incompatible with the above-described transparent material, having a refractive index different from that of the transparent material and which have a function to diffuse transmitted light passing through the light diffuser plate (31). For example, the light-diffusing agent may comprise inorganic particles made of an inorganic material or organic particles made of an organic material.

There is no limit in selection of the inorganic material constituting the inorganic particles. Examples of the inorganic material include silica, calcium carbonate, barium sulfate, titanium oxide, aluminum hydroxide, inorganic glass, mica, talc, white carbon, magnesium oxide, zinc oxide and the like.

There is no limit in selection of the organic material constituting the organic particles. Examples of the organic material include methacrylic crosslinked resins, methacrylic polymeric resins, styrene-based crosslinked resins, styrene-based polymeric resins, siloxane-based polymers and the like.

The particle size of the inorganic particles or the organic particles for use as the light-diffusing agent is usually from 0.1 to 50 μm.

The amount of the light-diffusing agent to be used may differ depending on an intended degree of diffusion of transmitted light. The amount thereof is usually from 0.01 to 20 parts by mass, preferably from 0.1 to 10 parts by mass, per 100 parts by mass of the transparent resin.

Preferably, the contact surface of the light diffuser plate (31) to the primer layer (32) is formed as follows:

a) it is formed as an uneven surface (31a) having an irregular cross-sectional shape in which the ten-point height of roughness profile (Rz) is from 20 to 100 μm (see FIG. 1 and FIG. 1-31); or

b) it is formed as an uneven surface (31a) having a regular cross-sectional shape (see FIG. 4-27 and FIG. 5).

When the light diffuser plate (31) having such a structure is used, a sufficient air gap (43) can be formed between the light diffuser plate (31) and the optical film (41), and thus, the laminated optical member (3) can ensure a sufficient luminance.

In the light diffuser plate (31) which has the uneven surface (31a) having the former irregular cross-sectional shape, if Rz is less than 20 μm, the adhesive layer (40) is apt to enter the bottom (or the grooves) of the uneven surface (31a) of the light diffuser plate (31), with an undesirable result that it becomes difficult to ensure a sufficient clearance as the air gap (43). On the other hand, if Rz exceeds 100 μm, undesirably, the bonding strength between the light diffuser plate (31) and the optical film (41) tends to decrease.

The uneven surface (31a) having the above-described irregular cross-sectional shape is formed as follows: for example, when the light diffuser plate (31) is shaped by co-extrusion multilayer casting, particles with large particle sizes (i.e., a matting agent) are added to the surface layer of the light diffuser plate, so that at least one surface of a light diffuser plate (31) can be formed as the uneven surface (31a) having the above-described irregular cross-sectional shape; or otherwise, a mat roller is used when the light diffuser plate (31) is molded by extrusion, so as to make a melt extrusion and transfer molding on the light diffuser plate, so that the uneven surface (31a) having the irregular cross-sectional shape can be formed.

While the latter regular cross-sectional shape of the uneven surface is not limited, such a regular cross-sectional shape is, for example, in a lenticular lens shape, waveform shape, prismatic shape or the like (see FIG. 4-27 and FIG. 5). When the uneven surface (31a) of the light diffuser plate has the latter regular cross-sectional shape, the height of the protrusions (or the depth of the grooves) (H) of the uneven surface (31a) is usually from 5 μm to 1 mm; and the pitch interval (P) between each of the adjacent protrusions is usually from 3 μm to 3.5 mm (see FIG. 4-27 and FIG. 5). When the regular cross-sectional shape is in the shape of a prismatic shape, the apex angle (α) thereof is preferably from 40 to 120° (see FIG. 4-27 and FIG. 5).

The thickness (S) of the light diffuser plate (31) is usually set at from 0.1 to 10 mm.

The primer layer (32) is provided to increase the bonding strength of other member such as the optical film (41) to the light diffuser plate (31). For example, the primer layer(s) (32) is formed by applying a primer solution to the surface(s) (one or both surfaces) of the light diffuser plate (31). In an embodiment of the present invention, the primer layer (32) is formed by applying the primer solution from below to the downward facing uneven surface (31a) of the light diffuser plate (31).

Examples of the primer solution include, but not limited to, solutions each of which contains some of synthetic resins, coupling agents, highly active compounds, solvents, etc., optionally selected for use in combination.

Examples of the synthetic resin constituting the primer solution include, but not limited to, urethane-based resins, acrylic resins, epoxy-based resins, synthetic rubber-based resins, resorcinol-based resins, etc. The use of the synthetic resin is effective for the primer layer (32) to maintain a certain thickness, and the synthetic resin acts as a buffer to a stress to the bonding interface. Above all, the use of the urethane-based resin is preferable to sufficiently improve the bonding strength.

Examples of the coupling agent constituting the primer solution include, but not limited to, silane-based coupling agents, titanate-based coupling agents, aluminum-based coupling agents, zirconium-based coupling agents, etc.

Examples of the highly active compound constituting the primer solution include, but not limited to, isocyanates, acrylic derivatives, etc.

Examples of the solvent constituting the primer solution include, but not limited to, emulsion type solvents and aqueous solvents in addition to organic solvents such as toluene, xylene, ethyl acetate, methyl cellosolve and methyl ethyl ketone. Among those, an aqueous primer solution is preferable, because the use thereof is advantageous to sufficiently improve the work environment for the production.

The thickness of the primer layer (32) in a dried state is preferably set at from 1 to 20 μm. The primer layer with a thickness of 1 μm or more ensures a sufficient bonding strength, while the primer layer with a thickness of 20 μm or less makes it sure to prevent the primer solution (32) from fully filling the grooves of the uneven surface (31a) of the light diffuser plate (31) and ensures a sufficient clearance for the air gap (43).

In the above-described embodiment, the primer layer (32) is formed on the entire uneven surface (31a) of the light diffuser plate (31). However, the mode for forming the primer layer is not limited to this one. For example, the primer layer (32) may be partially laminated on the uneven surface (31a) of the light diffuser plate (31). In this case, preferably, the primer layer (32) is laminated on at least the protrusions (at their top portions) of the uneven surface (31a).

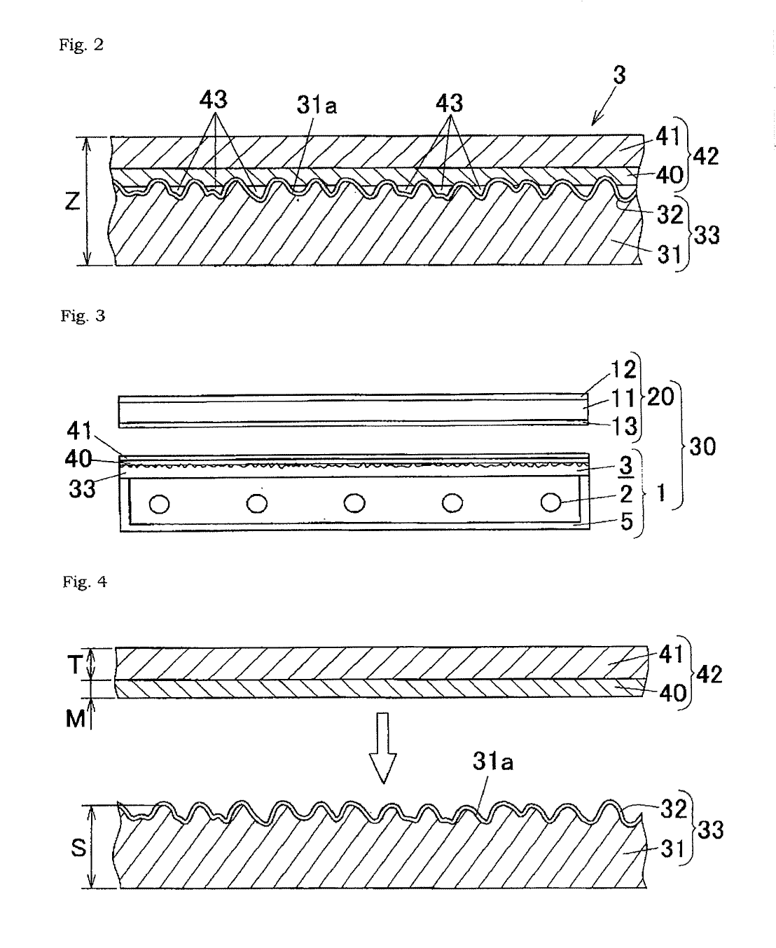

Next, the laminated optical member (3) according to the present invention will be described. An embodiment of the laminated optical member (3) is shown in FIG. 2. The laminated optical member (3) is obtained by integrally laminating the optical film (41) on the primer layer (32) of the above-described light diffuser plate (33) through the adhesive layer (40). As seen in FIG. 2, the air gap (43) is formed between the adhesive layer (40) laminated on the optical film (41) and the primer layer (32) which is laminated in an irregular corrugated state alongside the uneven pattern of the uneven surface (31a) of the light diffuser plate (31). In this regard, the adhesive layer (40) is laminated on substantially the entire surface of the optical film (41) without any clearance therebetween, while the primer layer (32) is laminated on the uneven surface (31a) of the light diffuser plate (31) without any clearance therebetween.

In the above-described laminated optical member (3), the air gap (43) is formed between the adhesive layer (40) and the primer layer (32) laminated alongside the uneven pattern of the uneven surface (31a) of the light diffuser plate (31) of the present invention: in other words, the air gap (43) is formed between the light diffuser plate (31) and the optical film (41). Therefore, the use of this laminated optical member (3) for the assembling of a surface light source apparatus (1) or a liquid crystal display (30) makes it sure for such an apparatus to obtain a sufficient luminance.

While there is no limit in selection of a material for the adhesive layer (40), examples of such a material include acrylic adhesives, urethane-based adhesives, polyether-based adhesives, silicone-based adhesives, and adhesives other than these adhesives. Among those, a colorless and transparent self-adhesive is preferable, because the use thereof is effective to provide a higher quality display image. Preferably, a pressure sensitive adhesive is used for the adhesive layer (40).

The thickness (M) of the adhesive layer (40) is preferably set at from 1 to 30 μm. The adhesive layer with a thickness of 1 μm or more makes it possible to ensure a sufficient bonding strength, while the adhesive layer with a thickness of 30 μm or less makes it sure to prevent the adhesive layer (40) from contacting the bottom (or the grooves) of the uneven surface of the light diffuser plate (33) so that a sufficient clearance for the air gap (43) can be ensured. Above all, the thickness (M) of the adhesive layer (40) is particularly set at from 1 to 25 μm.

While there is no limit in selection of the optical film (41), examples thereof include a light-diffusing film, a prism film, a reflection type light-polarization separation film, a phase retardation film, a polarizing film, etc.

While there is no limit in selection of the light-diffusing film (41), for example, a transparent film in which beads are fixed on its one surface with a binder is used. Example of a resin constituting the transparent film include polyolefins such as polyethylene and polypropylene, polyvinyl chloride, polyvinylidene chloride, polyvinyl acetate, polyester, polymethyl methacrylate, polystyrene, polycarbonate, polyamide, polyimide, polyamideimide, aromatic polyamide, polyethylene terephthalate, biaxial oriented polyethylene terephthalate, polyethylene naphthalate, cellulose acylate, cellulose triacetate, cellulose acetate propionate, cellulose diacetate, etc. The diameter of the beads is usually 100 μm or less.

While there is no limit in selection of the prism film (41), it is usually formed of a transparent resin. For example, there is given a sheet in which fine light-collecting lenses such fine prism lenses, fine convex lenses, lenticular lenses or the like are provided on an entire surface thereof, opposite the surface thereof to be laminated on the light diffuser plate (33) with the primer layer. Light beams which pass through the light diffuser plate (31) while being diffused are converged in a normal line direction by this prism film, so as to illuminate the front side of the apparatus at a higher luminance.

As the prism film (41), there is used a film which comprises a base material selected from thermoplastic resins such as polycarbonate resins, ABS (acrylonitrile-butadiene-styrene copolymer) resins, methacrylic resins, methyl methacrylate-styrene copolymer resins, polystyrene resins, acrylonitrile-styrene copolymer (AS) resins, and polyolefin resins (e.g., polyethylene resins, polypropylene resins, etc.). There is no limit in selection of a commercially available product of the prism film (41). Examples of such a commercially available product include “BEF® (Brightness Enhancement Film)” available from SUMITO 3M LIMITED (which comprises a polyester film with a thickness of 125 μm and an acrylic resin layer with a thickness of 30 μm formed on the polyester film and which has V-shaped grooves with depths of 25 μm formed on the acrylic resin layer at pitch intervals of 50 μm, having opening angles of 90°), “ESTINA®” available from SEKISUI FILM CO., LTD., “Illuminex® ADF film” available from GE Plastics, etc.

The reflection type light-polarization separation film (41) transmits polarized light beams of a certain type and reflects polarized light beams of the reverse type. Specific examples thereof include a reflection type linear polarization separation film which transmits linearly polarized light beams oscillating in a specified direction and which reflects linearly polarized light beams oscillating in a direction orthogonal to the former direction, and a reflection type circularly polarization separation film which transmits circularly polarized light beams rotating in a certain direction and which reflects circularly polarized light beams rotating in a reverse direction. As commercially available products of the reflection type linear polarization separation film, there are exemplified “DBEF® (Dual Brightness Enhancement Film)” available from SUMITOM 3M LIMITED, “NIPOX®” available from NITTO DENKO CORPORATION, etc.

The phase retardation film (41) is produced by stretching a resin film to cause retardation. As a material for the resin film, there is used, for example, a polycarbonate-based resin, a polysulfone-based resin, a polyether sulfone-based resin, a polyarylate-based resin, a norbornene-based resin or the like. A known method may be employed to stretch the film: that is, vertical stretching such as inter-roller stretching or lateral stretching such as tenter stretching may be employed. There may be employed unidirectional stretching; or otherwise, a film stretched in the thickness direction may be used so as to adjust a viewing angle for a liquid crystal display. The phase retardation value of the phase retardation film may be appropriately selected in accordance with desired characteristics. However, a phase retardation film with a phase retardation value of from 100 to 1,000 nm is generally used. In one of preferred modes, a ¼ wavelength film or a ½ wavelength film is used. Examples of a commercially available product of the phase retardation film (41) include “Elmec®” available from KANEKA CORPORATION, “Sumikalight®” available from Sumitomo Chemical Company, Limited, etc.

The polarizing film (41) is obtained by stretching a polyvinyl alcohol film, dyeing the film with an iodine or a dichroism dye, and adsorbing and orienting such an iodine or such a dye on the film. The polarizing film transmits linearly polarized light beams which oscillate in a direction orthogonal to the orienting direction and absorbs linearly polarized light beams which oscillate in the same direction as the orienting direction. In this regard, polyvinyl alcohol is preferably coated with a protective film because of its poor water resistance. Usually, cellulose triacetate is used for such a protective film. Examples of a commercially available product of the polarizing film (41) include “NPF®” available from NITTO DENKO CORPORATION, “Sumikalan®” available from Sumitomo Chemical Company, Limited, etc.

The thickness (T) of the foregoing optical film (41) is usually from 0.02 to 5 mm, preferably from 0.02 to 2 mm.

While the thickness (Z) of the foregoing laminated optical member (3) is not limited, it is usually from 1 to 3 mm.

For example, the laminated optical member (3) of the present invention is assembled as follows. A self-adhesive is applied to one surface of the optical film (41), for example, by gravure coating, to form an adhesive layer (40) on one surface of the optical film (41). Thus, the laminated film (42) is obtained (see FIG. 4). On the other hand, the light diffuser plate (31) having the uneven surface (31a) on its one surface is prepared. The light diffuser plate (33) which comprises the light diffuser plate (31) and the primer layer (32) laminated on the uneven surface (31a) of the light diffuser plate (31) is obtained by applying the primer solution to the uneven surface (31a) of the light diffuser plate (31), for example, by bar coating (see FIG. 4). Then, as shown in FIG. 4, the light diffuser plate (33) and the laminated film (42) are superposed and pressed on each other so that the adhesive layer (40) can contact the uneven surface (31a) of the light diffuser plate (33). By doing so, the light diffuser plate (33) and the optical film (41) is bonded to each other through the adhesive layer (40) to obtain the laminated optical member (3) of the present invention as shown in FIG. 2.

The foregoing process is illustrative only, and the laminated optical member (3) of the present invention is not limited to one produced by the above-described process.

In the laminated optical member (3) of the above-described embodiment, the optical film (41) is laminated on only one surface of the light diffuser plate (33) through the adhesive layer (40). However, the laminated optical member (3) is not limited to such one: for example, the optical films (41) may be laminated on both surface of the light diffuser plate (33) through the adhesive layers (40). In this case, preferably, the primer layers (32) are laminated on both surfaces of the light diffuser plate (33), and it is needed to laminate the primer layer (32) on at least one surface of a light diffuser plate (33).

Next, some examples of usage of the laminated optical member (3) produced by the process of the present invention will be described. FIG. 3 shows an embodiment of a liquid crystal display (30) assembled using the above-described laminated optical member (3). In FIG. 3, a numeral (30) refers to a liquid crystal display; (11), to a liquid crystal cell; (12) and (13), to polarizing plates; and (1), to a surface light source apparatus (or a backlight). The polarizing plates (12) and (13) are disposed on the upper and lower sides of the liquid crystal cell (11), respectively, and these members (11), (12) and (13) constitute a liquid crystal panel (20) as an image-displaying member. As the liquid crystal cell (11), such one capable of displaying a colored picture image is preferably used.

The surface light source apparatus (1) is arranged on the side of the lower surface (or the back side) of the lower polarizing plate (13) of the liquid crystal panel (20). Thus, this liquid crystal display (30) is a direct type liquid crystal display.

The surface light source apparatus (1) comprises a lamp box (5) in the shape of a slim casing which is rectangular in plan view and is opened at its upper surface (or the front side), a plurality of light sources (2) spaced from one another in the lamp box (5), and a laminated optical member (3) disposed on the upper side (or the front side) of the plurality of light sources (2). This laminated optical member (3) has the above-described structure, and is so fixed to the lamp box (5) as to close the opening thereof. Also, a reflecting layer (not shown) is laminated on the inner surfaces of the lamp box (5). In this embodiment, linear light sources such as cold cathode ray tubes are used as the light sources (2).

In the liquid crystal display (30), the laminated optical member (3) is so disposed that the optical film (41) thereof can be set to be at the front side (on the side of the liquid crystal panel (20)) (see FIG. 3). In other words, in the liquid crystal display (30), the laminated optical member (3) is so disposed that the light diffuser plate (33) thereof can be set to be at the back side (on the side of the light sources (2)) (see FIG. 3).

The surface light source apparatus (1) or the liquid crystal display (30) is assembled using the laminated optical member (3) which comprises the lamination of the light diffuser plate (33) and the optical film (41), and thus is sufficiently improved in handling efficiency and productivity. Further, the bonding strength of the light diffuser plate (33) to the optical film (41) becomes sufficient, so that the apparatus can have high duration and high quality. Furthermore, a sufficient air gap (43) formed between the light diffuser plate (33) and the optical film (41) provides a higher luminance.

While the light sources (2) used in the surface light source apparatus (1) or the liquid crystal display (30) are not limited, for example, spot light sources such as light-emitting diodes (LEDs) may be used in addition to the linear light sources such as fluorescent lamps, halogen lamps, tungsten lamps and EEFLs (external electrode fluorescent lamps).

While the dimensions (or the areas) of the light diffuser plate (33) with the primer layer and of the laminated optical member (3) are not limited, such dimensions or such areas may be appropriately selected in accordance with the dimensions of, for example, an intended surface light source apparatus (1) or an intended liquid crystal display (30). Such dimensions are usually from 20×30 cm to 150×200 cm.

The light-diffuser-plate-with-primer-layer, the laminated optical member, the surface light source apparatus and the liquid crystal display and their production processes are not limited to the foregoing embodiments. They may be optionally altered or changed in their designs, in so far as such alternation or changes do not depart from the spirit of the present invention.

### EXAMPLES

Next, specific examples of the present invention will be illustrated, which however should not be construed as limiting the scope of the present invention in any way.

### Example 1

### Preparation of Light-Diffusing Agent Master Batch

Styrene resin pellets (“HRM40” manufactured by TOYO STYRENE CO., LTD.; refractive index: 1.59) (54 parts by mass), acrylic polymer particles (crosslinked polymer particles, “SUMIPEX XC1A” manufactured by Sumitomo Chemical Company, Limited; refractive index: 1.49; volume-average particle size: 25 μm (40 parts by mass), siloxane-based polymer particles (crosslinked polymer particles, “Trefil DY33-719” manufactured by Dow Corning Toray; refractive index: 1.42; volume-average particle size: 2 μm (4 parts by mass), a thermal stabilizer (“Sumisorb 200” in the form of powder, manufactured by Sumitomo Chemical Company, Limited) (2 parts by mass) and a processing stabilizer (“Sumilizer GP” in the form of powder, manufactured by Sumitomo Chemical Company, Limited) (2 parts by mass) were dry-blended. Then, this blend was charged in the hopper of a twin-screw extruder and was melt-kneaded while being heated. After that, this knead mixture was extruded at 250° C. to obtain a strand, which was then cut into pellets. Thus, a light-diffusing agent master batch (in the form of pellets) was obtained.

### (Preparation of Coarse Particle-Containing Resin Composition)

The following were dry-blended to obtain a coarse particle-containing resin composition: that is, they were a styrene-methyl methacylate copolymer resin (“MS200NT” manufactured by Nippon Steel Chemical Co., Ltd.; styrene unit: 80% by mass; methyl methacrylate unit: 20% by mass; refractive index: 1.57) (68.8 parts by mass), acrylic polymer particles (crosslinked polymer particles, “MBX80” manufactured by Sekisui Plastics Co., Ltd.; refractive index: 1.49; volume-average particle size: 80 μm) (30 parts by mass), a UV absorber (“Adekastab LA-31, 2,2′-methylene-bis(4-tert-octyl(6-2H-benzotriazole-2-yl)phenol) in the form of powder, manufactured by Asahi Denka Co., Ltd.) (1 part by mass) and a processing stabilizer (“Sumilizer GP” in the form of powder, manufactured by Sumitomo Chemical Company, Limited) (0.2 parts by mass).

### (Production of Multi-Layer Light Diffuser Plate)

Styrene resin pellets (“HRM40” manufactured by TOYO STYRENE CO., LTD.; refractive index: 1.59) (95 parts by mass) and the above-described light-diffusing agent master batch (5 parts by mass) were dry-blended. Then, this blend was supplied to an extruder with a screw diameter of 40 mm and was heated to 235° C. under a pressure of 5.3 kPa (absolute pressure) at the vent section, to obtain a molten light-diffusing resin composition. On the other hand, the above-described coarse particle-containing resin composition was supplied to an extruder with a screw diameter of 20 mm and was heated to 230° C. under a pressure of 21.3 kPa (absolute pressure) at the vent section, to obtain a molten coarse particle-containing resin composition.

The light-diffusing resin composition and the coarse particle-containing resin composition were supplied to a feed block (with a three-layer structure for two kinds) and were co-extruded with a width of 220 mm from the T die at a temperature of from 245 to 250° C. Thus, there was obtained a light diffuser plate (with a thickness of 2 mm and a width of 220 mm) with a three-layer structure, having both surfaces formed as uneven surfaces, in which surface layers (with each thickness of 0.05 mm) were laminated on both surfaces of a main layer (with a thickness of 1.9 mm). The ten-point height of roughness profile (Rz) of the uneven surfaces of this light diffuser plate was 39.9 μm.

A primer solution comprising a mixture of “NeoRez® R-551” (100 parts by mass) manufactured by DSM Neoresins and “CARBODILITE® V02-L2” (8.3 parts by mass) manufactured by NISSHINBO INDUSTRIES, INC. was applied to one of the uneven surfaces of the light diffuser plate with a bar coater (of the type which forms a coating layer with a thickness of about 30 μm in a wet state). Thus, there was obtained a light diffuser plate (33) which had a primer layer (32) laminated on one uneven surface (31a) of the light diffuser plate (31) (see FIG. 1).

### Example 2

A light diffuser plate was obtained in the same manner as in Example 1, except that there was used a primer solution comprising a mixture of “NeoRez® R-600” (100 parts by mass) manufactured by DSM Neoresins and “CARBODILITE® V02-L2” (7.5 parts by mass) manufactured by NISSHINBO INDUSTRIES, INC.

### Example 3

There was produced a synthetic resin-made light diffuser plate (31) with a thickness of 2 mm which had an uneven surface (31a) formed on one surface thereof by forming a plurality of cylindrical lens-shaped protrusions on the entire surface by melt extrusion and transfer molding with the use of an engraved roller (see FIG. 6). In this light diffuser plate (31), the height (H) of each of the substantially semi-circular sections of the cylindrical protrusions was about 100 μm; each of the pitch intervals (P) between each of the adjacent protrusions having the substantially semi-circular sections was about 230 μm; and each of the widths (E) of the flat-bottomed grooves between each of the adjacent protrusions was about 15 μm.

A primer solution comprising a mixture of “NeoRez® R-551” (100 parts by mass) manufactured by DSM Neoresins and “CARBODILITE® V02-L2” (8.3 parts by mass) manufactured by NISSHINBO INDUSTRIES, INC. was applied to the uneven surface (31a) of the light diffuser plate (31) with a bar coater (of the type which forms a coating layer with a thickness of about 30 μm in a wet state). Thus, there was obtained a light diffuser plate (33) which had a primer layer (32) laminated on one uneven surface (31a), having a regular cross-sectional shape, of the light diffuser plate (31) (see FIG. 6).

### Comparative Example 1

A light diffuser plate was obtained in the same manner as in Example 1, except that no primer solution was applied (i.e., no primer layer was formed).

In this regard, the above-described ten-point height of roughness profile (Rz) was measured according to the following method.

### <Measurement of Ten-Point Height of Roughness Profile (Rz)>

“Surf-Test SJ-201P”, a measuring instrument manufactured by Mitutoyo Corporation was used to measure a ten-point height of roughness profile in accordance with JIS B0601-1994. The measurement was made 5 times on a length of 2.5 mm. The measurement was repeated 3 times for every sample (every Example), and an average thereof was defined as Rz.

Each of the light diffuser plates thus obtained was evaluated by the following method. The results are shown in Table 1.

### <Evaluation of Peel Strength>

Each of the light diffuser plates was cut into rectangular pieces of 7.5 cm×12.5 cm. On the other hand, a laminated film was prepared in which an adhesive layer is laminated on one surface of a reflection type light-polarization separation film (“DBEF” manufactured by SUMITOMO 3M LIMITED) cut with a size of 1.5 cm×28.0 cm. Next, as shown in FIG. 4, the light diffuser plate (33) as cut above and the laminated film (42) were superposed and pressed on each other so that the adhesive layer (40) could contact the primer layer (32) on the uneven surface (31a) of the light diffuser plate. Thus, a laminated optical member (3) shown in FIG. 2 or 6 was obtained.

The peel strength of the laminated optical member was measured with Strograph “R-200” manufactured by Toyo Seiki Co., Ltd. That is, a peel strength between the light diffuser plate and the reflection type light-polarization separation film was measured, using a load cell with a weight of 10 kg, at a peeling rate of 300 mm/second and at a peeling angle of 180°. The data obtained for the first 4 seconds after the start of the measurement were excluded from the measured data. The peel strength was determined from the results of the measurement for 20 seconds after the first 4 seconds. The measurement was conducted twice on each of the samples of Examples, and an average thereof was defined as the peel strength.

TABLE 1

| | | Uneven surface of | |
|---|---|---|---|
| | | light diffuser plate | Peel |
| | Primer | (Examples 1 to 3: Contact | strength |
| | layer | surfaces to primer layers) | (g/inch) |
| Ex. 1 | Formed | Irregular cross-sectional shape; | 90 |
| | | Rz = 39.9 μm | |
| Ex. 2 | Formed | Irregular cross-sectional shape; | 79 |
| | | Rz = 39.9 μm | |
| Ex. 3 | Formed | Regular cross-sectional shape | 495 |
| C. Ex. 1 | Not formed | Irregular cross-sectional shape; | 3.6 |
| | | Rz = 39.9 μm | |

As is apparent from Table 1, the light diffuser plates of Examples 1 to 3 of the present invention could obtain sufficient peel strengths in view of adhesion to the optical films. In other words, the laminated optical members of the present invention, obtained by laminating the optical films on the primer layers of the light diffuser plates of Examples 1 to 3 of the present invention, through the adhesive layers, had sufficient bonding strengths and superior durability.

In contrast, the light diffuser plate without any primer layer of Comparative Example 1 was extremely low in the bonding strength to the optical film.

### Example 4

### Preparation of Light-Diffusing Agent Master Batch

Styrene resin pellets (“HRM40” manufactured by TOYO STYRENE CO., LTD.; refractive index: 1.59) (54 parts by mass), acrylic polymer particles (crosslinked polymer particles, “SUMIPEX XC1A” manufactured by Sumitomo Chemical Company, Limited; refractive index: 1.49; volume-average particle size: 25 μm) (40 parts by mass), siloxane-based polymer particles (crosslinked polymer particles, “Trefil DY33-719” manufactured by Dow Corning Toray; refractive index: 1.42; volume-average particle size: 2 μm) (4 parts by mass), a thermal stabilizer (“Sumisorb 200” in the form of powder, manufactured by Sumitomo Chemical Company, Limited) (2 parts by mass) and a processing stabilizer (“Sumilizer GP” in the form of powder, manufactured by Sumitomo Chemical Company, Limited) (2 parts by mass) were dry-blended. Then, this blend was charged in the hopper of a twin-screw extruder and was melt-kneaded while being heated. After that, this knead mixture was extruded at 250° C. to obtain a strand, which was then cut into pellets. Thus, a light-diffusing agent master batch (in the form of pellets) was obtained.

### (Preparation of Coarse Particle-Containing Resin Composition)

The following were dry-blended: that is, they were a styrene-methyl methacylate copolymer resin (“MS200NT” manufactured by Nippon Steel Chemical Co., Ltd.; styrene unit: 80% by mass; methyl methacrylate unit: 20% by mass; refractive index: 1.57) (68.8 parts by mass), acrylic polymer particles (crosslinked polymer particles, “MBX80” manufactured by Sekisui Plastics Co., Ltd.; refractive index: 1.49; volume-average particle size: 80 μm) (30 parts by mass), a UV absorber (“Adekastab LA-31”, 2,2′-methylene-bis(4-tert-octyl(6-2H-benzotriazole-2-yl)phenol) in the form of powder, manufactured by Asahi Denka Co., Ltd.) (1 part by mass) and a processing stabilizer (“Sumilizer GP” in the form of powder, manufactured by Sumitomo Chemical Company, Limited) (0.2 parts by mass). This dry blend was charged in the hopper of a twin-screw extruder and was melt-kneaded while being heated. The knead composition was extruded into a strand, which was then cut into pellets. Thus, a coarse particle-containing resin composition was obtained.

### (Production of Multilayer Light Diffuser Plate)

Polystyrene resin pellets (“HRM40” manufactured by TOYO STYRENE CO., LTD.; refractive index: 1.59) (89 parts by mass) and the above-described light-diffusing agent master batch (11 parts by mass) were dry-blended. Then, this blend was supplied to an extruder with a screw diameter of 130 mm and was heated to obtain a molten light-diffusing resin composition. On the other hand, the above-described coarse particle-containing resin composition was supplied to an extruder with a screw diameter of 50 mm and was heated to obtain a molten coarse particle-containing resin composition.

The light-diffusing resin composition and the coarse particle-containing resin composition were supplied to a feed block (with a three-layer structure for two kinds) and were co-extruded from the T die to obtain a light diffuser plate (with a thickness of 2 mm and a width of 1,300 mm) with a three-layer structure, having both surfaces formed as uneven surfaces, in which surface layers (with each thickness of 0.05 mm) were laminated on both surfaces of a main layer (with a thickness of 1.9 mm). The ten-point height of roughness profile (Rz) of the uneven surfaces of this light diffuser plate was 32.1 μm.

The light diffuser plate thus obtained was cut to obtain an A4 size light diffuser plate. This cut light diffuser plate was set in an oven of 70° C. and was retained therein until the plate was heated to 70° C. After that, the light diffuser plate was removed from the oven, and the temperature thereof was immediately measured (the found temperature: 68° C.). Immediately after that, an aqueous primer solution comprising a mixture of “NeoRez® R-551” (100 parts by mass) manufactured by DSM Neoresins and “CARBODILITE® V02-L2” (8.3 parts by mass) manufactured by NISSHINBO INDUSTRIES, INC. was applied to one of the uneven surfaces of the light diffuser plate (i.e., the uneven surface faced upward) with a bar coater (of the type which forms a coating layer with a thickness of about 30 μm in a wet state). Thus, there was obtained a light diffuser plate which had a primer layer laminated on one uneven surface thereof.

### Example 5

A light-diffuser-plate-with-primer-layer was obtained in the same manner as in Example 4, except that the light diffuser plate was removed from the oven of 70° C. and was left to stand as it was, and that the primer solution was applied thereto when the temperature of the plate had reached 58° C.

### Reference Example 1

A light-diffuser-plate-with-primer-layer was obtained in the same manner as in Example 4, except that the cut light diffuser plate was left to stand in a room without setting it in the oven, and that the primer solution was applied thereto when the temperature of the plate had become constant at 26° C.

Each of the light diffuser plates with the primer layers thus obtained was evaluated by the following method. The results are shown in Table 2.

### <Method for Evaluating Drying Time>

Time counting was started simultaneously with application of the primer solution to the uneven surface of the light diffuser plate, and a time when no fingerprint had been adhered to the coating layer by one's finger touching the same layer was counted. This time was defined as a drying time.

TABLE 2

| | Ex. 4 | Ex. 5 | Ref. Ex. 1 |
|---|---|---|---|
| Temp. (° C.) of light diffuser | 68 | 58 | 26 |
| plate found just before | | | |
| application of primer solution | | | |
| Drying time (second) | 25 | 35 | 150 |

As is apparent from Table 2, the drying time was shorter in each of the production processes of Examples 4 and 5, since the primer solution was applied to the light diffuser plate which retained a temperature of 50° C. or higher. Therefore, the primer solution could be sufficiently dried by the remaining heat of the light diffuser plate extruded, in the midway of the extrusion line at a conventional line speed of an extruder (e.g., 2 to 5 m/min.): for example, the primer solution could be sufficiently dried before the light diffuser plate had reached the masking rollers (53) (see FIG. 1-31). Therefore, these processes are superior in productivity.

In contrast, in the production process of Reference Example 1, a longer drying time was required, since the primer solution was applied to the light diffuser plate which had a temperature of 26° C.

### INDUSTRIAL APPLICABILITY

While any of the light diffuser plates of the present invention can be suitably used as a light diffuser plate for a surface light source apparatus, the application thereof is not limited to such one. While any of the laminated optical members of the present invention can be suitably used as an optical member for a surface light source apparatus, the application thereof is not limited to such one. While any of the surface light source apparatuses of the present invention can be suitably used as a backlight for a liquid crystal display, the application thereof is not limited to such one.

1. A light-diffuser-plate-with-primer-layer, wherein a primer layer is laminated on at least one surface of a light diffuser plate.

2. The light-diffuser-plate-with-primer-layer according to claim 1, wherein the contact surface of the light diffuser plate to the primer layer is formed as an uneven surface having an irregular cross-sectional shape and having a (Rz) of from 20 to 100 μm ((Rz): a ten-point height of roughness profile which is a value measured in accordance with JIS B0601-1994).

3. The light-diffuser-plate-with-primer-layer according to claim 1, wherein the contact surface of the light diffuser plate to the primer layer is formed as an uneven surface having a regular cross-sectional shape.

4. The light-diffuser-plate-with-primer-layer according to claim 3, wherein the regular cross-sectional shape is at least one shape selected from the group consisting of a lenticular lens shape, a waveform shape and a prismatic shape.

5. A process for producing the light-diffuser-plate-with-primer-layer according to claim 1, wherein a light diffuser plate having at least one surface formed as an uneven surface is set with its uneven surface faced downward, and a primer solution is applied from below the uneven surface faced downward of the light diffuser plate.

6. The process for producing the light-diffuser-plate-with-primer-layer according to claim 5, wherein the primer solution is applied by a roller coating method.

7. The process for producing the light-diffuser-plate-with-primer-layer according to claim 5, wherein the primer solution is applied by a spray coating method.

8. A process for producing a laminated optical member, comprising
a step of producing a laminated film in which an adhesive layer is laminated on one surface of an optical film,
a coating step of producing the light-diffuser-plate-with-primer-layer according to claim 1, by setting a light diffuser plate having at least one surface formed as an uneven surface with its uneven surface faced downward, and applying a primer solution from below the uneven surface faced downward of the light diffuser plate, and
a step of integrally laminating the laminated film on the light diffuser plate by superposing them on each other so that the adhesive layer of the laminated film can contact the primer solution-applied uneven surface of the light diffuser plate.

9. A process for producing the light-diffuser-plate-with-primer-layer according to claim 1, wherein the primer solution is applied to at least one surface of a light diffuser plate whose temperature is 50° C. or higher.

10. The process for producing the light-diffuser-plate-with-primer-layer according to claim 9, wherein the primer solution is applied to at least one surface of a light diffuser plate which is extruded from an extruder and retains a temperature of 50° C. or higher due to the residual heat of extrusion.

11. The process for producing the light-diffuser-plate-with-primer-layer according to claim 9, wherein at least one surface of a light diffuser plate is formed as an uneven surface, and the primer solution is applied to the uneven surface of the light diffuser plate.

12. The process for producing the light-diffuser-plate-with-primer-layer according to claim 9, wherein an aqueous primer solution is used as the primer solution.

13. A process for producing a laminated optical member, comprising
a step of producing a laminated film in which an adhesive layer is laminated on one surface of an optical film,
a coating step of producing the light-diffuser-plate-with-primer-layer according to claim 1, by applying a primer solution to at least one surface of a light diffuser plate whose temperature is 50° C. or higher, and
a step of integrally laminating the laminated film on the light diffuser plate by superposing them on each other so that the adhesive layer of the laminated film can contact the primer solution-applied surface of the light diffuser plate.

14. A laminated optical member, wherein an optical film is integrally laminated on the primer layer of the light-diffuser-plate-with-primer-layer according to claim 1, through an adhesive layer.

15. A laminated optical member, wherein an optical film is integrally laminated on the primer layer of the light-diffuser-plate-with-primer-layer according to claim 2, through an adhesive layer, and an air gap is formed between the adhesive layer and the primer layer laminated alongside an uneven pattern on the uneven surface of the light diffuser plate.

16. A surface light source apparatus comprising a laminated optical member according to claim 14, and a plurality of light sources disposed on the back side of the laminated optical member, wherein the optical film is set to be at the front side of the laminated optical member.

17. A liquid crystal display comprising a laminated optical member according to claim 14, a plurality of light sources disposed on the back side of the laminated optical member, and a liquid crystal panel disposed on the front side of the laminated optical member, wherein the optical film is set to be at the front side of the laminated optical member.
